(19) United States
(12) Patent Application Publication
(10) Pub. No.: US 2020/0004182 A1
(43) Pub. Date: Jan. 2, 2020

(54) HEATING DEVICE AND IMAGE FORMING APPARATUS

(71) Applicant: Oki Data Corporation, Tokyo (JP)

(72) Inventors: Ryoji YABUKI, Tokyo (JP); Junichi ITO, Tokyo (JP)

(73) Assignee: Oki Data Corporation, Tokyo (JP)

(21) Appl. No.: 16/415,302

(22) Filed: May 17, 2019

(30) Foreign Application Priority Data
Jun. 28, 2018 (JP) 2018-122941

(51) Int. Cl. G03G 15/20

(52) U.S. Cl. CPC G03G 15/2053; G03G 2215/2035; G03G 15/2039; G03G 15/2064

(57) ABSTRACT

A heating device includes a heating source, a belt member, a pressure-applying member, a plate member, and a lubricant. The belt member is heated by the heating source and moves in a predetermined moving direction. The pressure-applying member is brought into contact with the heating source with the belt member being disposed between the pressure-applying member and the heating source, and thereby provides a nip. The plate member is disposed between the heating source and the belt member, and includes an inclined part in an upstream region, a downstream region, or both. The upstream region and the downstream region are respectively disposed upstream and downstream of the nip in the predetermined moving direction of the belt member. The inclined part is inclined to be away from the nip. The lubricant is provided between the belt member and the plate member.

### CROSS REFERENCE TO RELATED APPLICATIONS

The present application claims priority from Japanese Patent Application No. 2018-122941 filed on Jun. 28, 2018, the entire contents of which are hereby incorporated by reference.

### BACKGROUND

The technology relates to a heating device including a heat source and a belt member, and to an image forming apparatus using the heating device.

As an image forming apparatus that forms an image on a print medium, an electrophotographic image forming apparatus is in widespread use. One reason for this is that the electrophotographic image forming apparatus is able to achieve a higher-quality image in a shorter time, compared with an image forming apparatus using other methods such as an inkjet method.

The electrophotographic image forming apparatus may include a developing section that performs a developing process, a transfer section that performs a transfer process, and a heating section or a fixing section that performs a fixing process. The electrophotographic image forming apparatus may form an image on a print medium with the use of a toner. The heating section may fix, to the print medium, the toner transferred onto the print medium, by heating the toner while applying pressure on the toner.

Some proposals have been made related to a configuration of the electrophotographic image forming apparatus. For example, lubricant grease is used in order to improve slidability of a flexible film against a heating member in a heating fixing apparatus. For example, reference can be made to Japanese Unexamined Patent Application Publication No. 2008-275756.

### SUMMARY

Various proposals have been made to improve a performance, of an image forming apparatus, related to image formation. For example, various proposals have been made to improve a heating characteristic of a heating device. However, there still is room for improvement in heating characteristic of the heating device.

It is desirable to provide a heating device and an image forming apparatus that each make it possible to obtain an improved heating characteristic.

According to one embodiment of the technology, there is provided a heating device that includes a heating source, a belt member, a pressure-applying member, a plate member, and a lubricant. The belt member is heated by the heating source and moves in a predetermined moving direction. The pressure-applying member is brought into contact with the heating source with the belt member being disposed between the pressure-applying member and the heating source, and thereby provides a nip. The plate member is disposed between the heating source and the belt member, and includes an inclined part in an upstream region, a downstream region, or both. The upstream region is disposed upstream of the nip in the predetermined moving direction of the belt member. The downstream region is disposed downstream of the nip in the predetermined moving direction of the belt member. The inclined part is inclined to be away from the nip. The lubricant is provided between the belt member and the plate member.

According to one embodiment of the technology, there is provided an image forming apparatus that includes a developing section, a transfer section, and a heating device. The developing section attaches a toner to an electrostatic latent image. The transfer section transfers, onto a print medium, the toner attached to the electrostatic latent image. The heating device includes a heating source, a belt member, a pressure-applying member, a plate member, and a lubricant. The belt member is heated by the heating source and moves in a predetermined moving direction. The pressure-applying member is brought into contact with the heating source with the belt member being disposed between the pressure-applying member and the heating source, and thereby provides a nip. The plate member is disposed between the heating source and the belt member, and includes an inclined part in an upstream region, a downstream region, or both. The upstream region is disposed upstream of the nip in the predetermined moving direction of the belt member. The downstream region is disposed downstream of the nip in the predetermined moving direction of the belt member. The inclined part is inclined to be away from the nip. The lubricant is provided between the belt member and the plate member. The heating device fixes, to the print medium, the toner transferred onto the print medium.

### BRIEF DESCRIPTION OF DRAWINGS

FIG. 1 is a perspective view of an example of a configuration of a heating device according to one embodiment of the technology.

FIG. 2 is a cross-sectional view of an example of a configuration of a main part of a heating device illustrated in FIG. 1.

FIG. 3 is a cross-sectional view of another example of the configuration of the main part of the heating device illustrated in FIG. 1.

FIG. 4 is a cross-sectional view of an example of a configuration of a separation plate illustrated in FIGS. 2 and 3.

FIG. 5 is a cross-sectional view of a configuration of a main part of a heating device according to a comparative example.

FIG. 6 is a cross-sectional view of an example of a configuration of a separation plate illustrated in FIG. 5.

FIG. 7 is a cross-sectional view of an example of a configuration of a main part of a heating device according to one embodiment of the technology.

FIG. 8 is a cross-sectional view of an example of a configuration of a main part of a heating device according to Modification example 1.

FIG. 9 is a cross-sectional view of an example of a configuration of a separation plate illustrated in FIG. 8.

FIG. 10 is a cross-sectional view of an example of a configuration of a main part of a heating device according to Modification example 2.

FIG. 11 is a cross-sectional view of an example of a configuration of a separation plate illustrated in FIG. 10.

FIG. 12 is a plan view of an example of a configuration of an image forming apparatus according to one embodiment of the technology.

### DETAILED DESCRIPTION

Hereinafter, some example embodiments of the technology will be described in detail with reference to the drawings. Note that the following description is directed to illustrative examples of the technology and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the technology are optional and may be provided on an as-needed basis. The drawings are schematic and are not intended to be drawn to scale. Note that the like elements are denoted with the same reference numerals, and any redundant description thereof will not be described in detail. The description will be given in the following order.

### 1. Heating Device (First Example Embodiment)

1-1. Configuration

1-2. Operation

1-3. Example Workings and Example Effects

### 2. Heating Device (Second Example Embodiment)

2-1. Configuration

2-2. Operation

2-3. Example Workings and Example Effects

### 3. Modification Examples

### 4. Image Forming Apparatus

4-1. Configuration

4-2. Operation

4-3. Example Workings and Example Effects

### 1. Heating Device (First Example Embodiment)

A description is given first of a heating device according to a first example embodiment of the technology.

A heating device described below may heat a heating target while applying pressure to the heating target. The heating target is not particularly limited in its type.

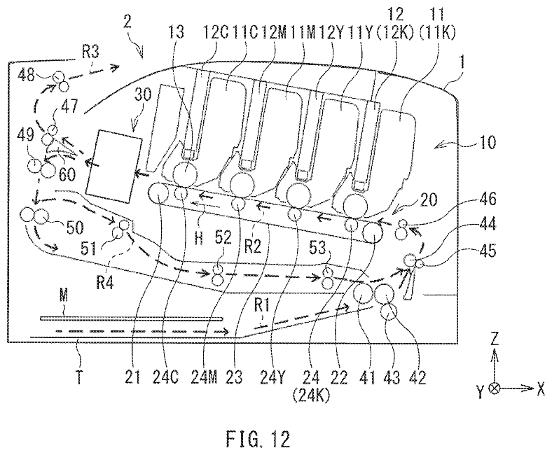

In an example case where the heating device is used in an image forming apparatus which will be described later with reference to FIG. 12, the heating target may be, for example, a print medium M. Non-limiting examples of the print medium M may include paper and any other printable medium.

### [1-1. Configuration]

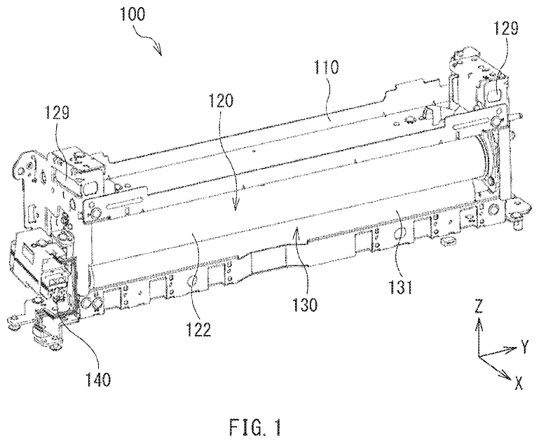

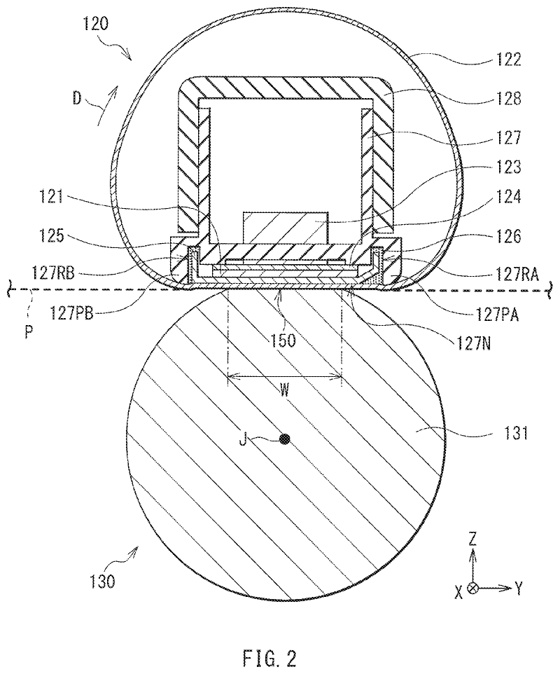

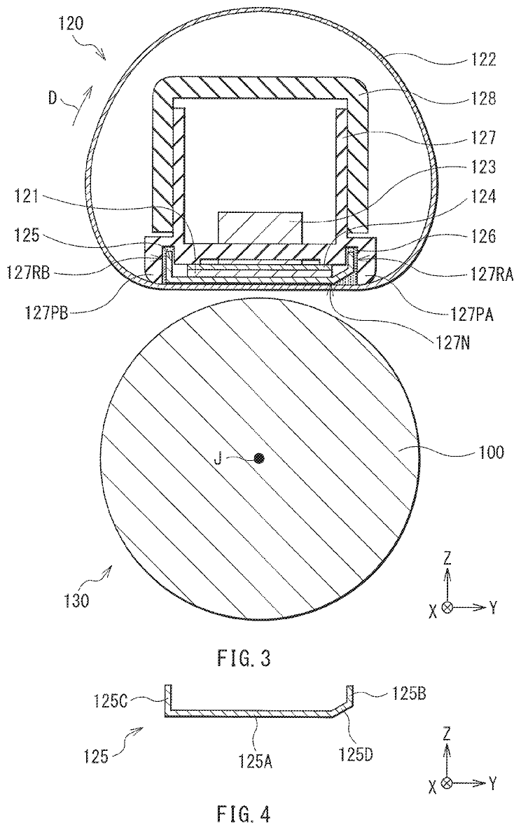

FIG. 1 illustrates a perspective configuration of a heating device 100. The heating device 100 may be an example of the heating device according to one embodiment of the technology. FIGS. 2 and 3 each illustrate a cross-sectional configuration of a main part of the heating device 100 illustrated in FIG. 1. FIG. 4 illustrates a cross-sectional configuration of a separation plate 125 illustrated in FIGS. 2 and 3. It is to be noted that FIG. 2 illustrates a state where a heating part 120 is in contact with a pressure-applying part 130, and FIG. 3 illustrates a state where the heating part 120 is separated away from the pressure-applying part 130. As used herein, a wording such as “be in contact with”, or its variants may encompass a state where one component is directly in contact with another component and also a state where one component is indirectly in contact with another component with any other component in between.

For example, as illustrated in FIGS. 1 to 3, the heating device 100 may include the heating part 120 and the pressure-applying part 130 inside a housing 110. The heating device 100 may also include a connector 140 outside the housing 110. In each of FIGS. 2 and 3, a dashed line indicates a feeding path P along which a heating target of the heating device 100 is fed. The heating target may be a target which is to be heated by the heating device 100.

### [Heating Part]

The heating part 120 may include, for example but not limited to, a heater 121, a heating belt 122, a temperature sensor 123, a heat transfer plate 124, a separation plate 125, a lubricant 126, a supporting member 127, a supporting member 128, and a pair of compression springs 129. The heater 121 may correspond to a “heat source” in one specific but non-limiting embodiment of the technology. The heating belt 122 may correspond to a “belt member” in one specific but non-limiting embodiment of the technology. The separation plate 125 may correspond to a “plate member” in one specific but non-limiting embodiment of the technology. As used herein, the term “plate” may be used interchangeably with the term “sheet”.

For example, as illustrated in FIG. 1, the heating part 120 may extend in a Y-axis direction. Accordingly, a series of components included in the heating part 120, such as the heater 121, may also extend in the Y-axis direction. Each of the pair of compression springs 129 may be, for example but not limited to, an elastic member that is expandable and contractible in a Z-axis direction. One of the pair of compression springs 129 may be attached to one end of the housing 110 in a direction in which the heating part 120 extends, for example. The other of the pair of compression springs 129 may be attached to the other end of the housing 110 in the direction in which the heating part 120 extends, for example.

Thereby, the heating part 120 may be movable in the Z-axis direction by utilizing expanding and contracting force of the pair of compression springs 129. For example, as illustrated in FIG. 2, in a case where the heating part 120 heats the heating target, the heating part 120 may move in a direction toward the pressure-applying part 130, i.e., in a downward direction in FIG. 2. The heating part 120 may thereby come into contact with the pressure-applying part 130. This may provide a nip 150 between the heating part 120 and the pressure-applying part 130. For example, this may provide the nip 150 between the heating belt 122 and a pressure-applying roller 131 which will be described later. The nip 150 may be a contact surface on an X-Y plane on which the heating belt 122 and the pressure-applying roller 131 come into contact with each other. The nip 150 may have a nip width W. The nip width W may be set to any width. The nip width W may be a length of the contact surface in the Y-axis direction. In contrast, as illustrated in FIG. 3, in a case where the heating part 120 does not heat the heating target, the heating part 120 may move in a direction away from the pressure-applying part 130, i.e., in an upward direction in FIG. 3. The heating part 120 may be thereby separated away from the pressure-applying part 130.

### [Heater]

The heater 121 may generate heat directed to heating of the heating belt 122. The heater 121 may receive power, for example, from outside via the connector 140. The heater 121 is not particularly limited in its type. Non-limiting examples of the heater 121 may include a planar heater.

### [Heating Belt]

The heating belt 122 may be a ring-shaped endless belt that is to be heated with the heat generated by the heater 121. The heating belt 122 may move in a predetermined direction, i.e., in a moving direction D, while being heated by the heater 121. For example, the heating belt 122 may include, for example but not limited to, a stack in which a base member, an elastic layer, and a surficial layer are stacked in this order. The base member may include, for example but not limited to, stainless steel (SUS). The elastic layer may include, for example but not limited to, silicon rubber. The surficial layer may include, for example but not limited to, a tetrafluoroethylene-perfluoro(alkylvinylether) copolymer (PFA) tube. Each of the heater 121, the temperature sensor 123, the heat transfer plate 124, the separation plate 125, the supporting member 127, and the supporting member 128 may be disposed, for example, on the inner side of the ring-shaped heating belt 122.

### [Temperature Sensor]

The temperature sensor 123 may detect a temperature of the heater 121, i.e., a heating temperature. The heat transfer plate 124 may be disposed between the heater 121 and the temperature sensor 123. Therefore, the temperature sensor 123 may detect the temperature of the heater 121 with the heat transfer plate 124 in between.

### [Heat Transfer Plate]

The heat transfer plate 124 may be disposed between the heater 121 and the temperature sensor 123. The heat transfer plate 124 may be a plate member that transfers, to the temperature sensor 123, the heat generated by the heater 121. In other words, the heat transfer plate 124 may be in contact with each of the heater 121 and the temperature sensor 123. The heat transfer plate 124 may include, for example but not limited to, a metal plate such as a stainless steel (SUS) plate.

### [Separation Plate]

The separation plate 125 may be disposed between the heater 121 and the heating belt 122. The separation plate 125 may be a plate member that separates the heating belt 122 away from the heater 121. In other words, the separation plate 125 may be in contact with each of the heater 121 and the heating belt 122. Therefore, the heater 121 and the pressure-applying roller 131 may be opposed to each other with the separation plate 125 in between. The separation plate 125 may have, for example, thermal conductivity, and thereby transfer, to the heating belt 122, the heat generated by the heater 121.

In one example, the separation plate 125 may be a metal plate such as a stainless steel (SUS) plate coated with glass, and therefore have high thermal conductivity. One reason for this may be that the heat generated by the heater 121 may be transferred more easily to the heating belt 122 via the separation plate 125. Therefore, it may be easier for the heating belt 122 to be heated by the heater 121. In this case, the separation plate 125 may serve as a so-called heat diffusing member or heat diffusing plate, for example. The separation plate 125 may diffuse the heat generated by the heater 121 in a process where the heat is transferred to the heating belt 122 via the separation plate 125, which is directed to more efficient heating of the heating belt 122 by utilizing the heat generated by the heater 121. Accordingly, it may be easier to heat the heating belt 122 uniformly as a result of heat diffusion. This suppresses unevenness in temperature of the heating belt 122.

Hereinafter, the +Z-axis direction or a direction similar to the +Z-axis direction may be referred to by terms such as “rearward”, a “rearward direction”, or their variants. The +Z-axis direction or a direction similar to the +Z-axis direction may be, for example, an upward direction in each of FIGS. 2 to 11. The −Z-axis direction or a direction similar to the −Z-axis direction may be referred to by terms such as “frontward”, a “frontward direction”, or their variants. The −Z-axis direction or a direction similar to the −Z-axis direction may be, for example, a downward direction in each of FIGS. 2 to 11. Similarly, a part positioned relatively rearward may be referred to as a “rear part” or its variant. A part positioned relatively frontward may be referred to as a “front part” or its variant. As illustrated in FIGS. 2 and 3, for example, the separation plate 125 may be bent in a rearward direction from the nip 150, i.e., in the upward direction in FIGS. 2 and 3, in an upstream region that is disposed upstream of the nip 150 in the moving direction D of the heating belt 122. Hereinafter, the upstream region that is disposed upstream of the nip 150 in the moving direction D of the heating belt 122 may also be simply referred to as an “upstream region of the nip 150”. The upstream region of the nip 150 may be disposed on the right side of each of FIGS. 2 and 3. For example, the separation plate 125 may be also bent in the rearward direction from the nip 150 in a downstream region that is disposed downstream of the nip 150 in the moving direction D of the heating belt 122. Hereinafter, the downstream region that is disposed downstream of the nip 150 in the moving direction D of the heating belt 122 may also be simply referred to as a “downstream region of the nip 150”. The downstream region of the nip 150 may be disposed on the left side of each of FIGS. 2 and 3.

For example, as illustrated in FIG. 4, the separation plate 125 may include a flat part 125A, a pair of bent parts, i.e., a bent part 125B and a bent part 125C, and an inclined part 125D.

The flat part 125A may extend in the Y-axis direction. In other words, the flat part 125A may extend in a direction along the nip 150, i.e., along a contact surface on which the heating belt 122 and the pressure-applying roller 131 are in contact with each other.

The bent part 125B may be positioned in the upstream region of the nip 150. The bent part 125B may extend in the Z-axis direction. Part or all of the bent part 125B may be positioned inside a storage chamber 127RA. The storage chamber 127RA may be provided in the supporting member 127. The storage chamber 127RA will be described later.

The bent part 125C may be positioned in the downstream region of the nip 150. The bent part 125C may extend in the Z-axis direction. Part or all of the bent part 125C may be positioned inside a storage chamber 127RB. The storage chamber 127RB may be provided in the supporting member 127. The storage chamber 127RB will be described later.

The inclined part 125D may be disposed between the flat part 125A and the bent part 125B. In other words, the inclined part 125D may be positioned in the upstream region of the nip 150. The inclined part 125D may be bent in the rearward direction from the nip 150. In other words, the inclined part 125D may be inclined in the rearward direction from the nip 150. An inclined angle of the inclined part 125D may be set to any angle. The inclined angle of the inclined part 125D may be an angle formed by a surface, of the flat part 125A, opposed to the heating belt 122 and a surface, of the inclined part 125D, opposed to the heating belt 122.

### [Lubricant]

The lubricant 126 may be liquid lubricant oil directed to smooth sliding of the heating belt 122 against the separation plate 125 in a state where the heating part 120 is in contact with the pressure-applying part 130. The lubricant 126 may be provided between the heating belt 122 and the separation plate 125. For example, the lubricant 126 may be applied to an inner surface of the ring-shaped heating belt 122, i.e., to a surface of the heating belt 122 on the separation plate 125 side. Accordingly, the lubricant 126 may be fed to a gap between the heating belt 122 and the separation plate 125. The lubricant 126 may thereby reduce frictional resistance generated between the heating belt 122 and the separation plate 125 when the heating belt 122 slides against the separation plate 125. For example, the lubricant 126 may include one or more types of additives together with the above-described liquid lubricant oil. In each of FIGS. 2 and 3, the lubricant 126 is indicated by a hatched part.

### [Supporting Member]

The supporting member 127 may support the heater 121. The supporting member 128 may hold the supporting member 127, and may be fixed to the housing 110. The temperature sensor 123 may be attached to the supporting member 127, for example.

The supporting member 127 may include, for example but not limited to, a pair of protrusions, i.e., a protrusion 127PA and a protrusion 127PB. The protrusion 127PA may correspond to a “first protrusion member” in one specific but non-limiting embodiment of the technology. The protrusion 127PB may correspond to a “second protrusion member” in one specific but non-limiting embodiment of the technology.

The protrusion 127PA may be disposed, for example, in the upstream region of the nip 150. The protrusion 127PA may protrude, for example, in a direction from the heater 121 toward the pressure-applying roller 131, i.e., in the downward direction in FIGS. 2 and 3. The protrusion 127PB may be disposed, for example, in the downstream region of the nip 150. The protrusion 127PB may protrude, for example, in the direction from the heater 121 toward the pressure-applying roller 131, as with the protrusion 127PA described above. Each of the protrusion 127PA and the protrusion 127PB may have a front end that is curved along a curved shape of the heating belt 122, for example.

Thus, a containing chamber 127N may be provided between the protrusion 127PA and the protrusion 127PB, for example. The containing chamber 127N may be, for example but not limited to, a depression between the protrusion 127PA and the protrusion 127PB. For example, the heater 121 and the separation plate 125 may be disposed inside the containing chamber 127N. In one example, the heater 121 and the flat part 125A of the separation plate 125 may be disposed inside the containing chamber 127N.

The storage chamber 127RA may be provided upstream of the containing chamber 127N in the moving direction D of the heating belt 122, i.e., between the protrusion 127PA and the heater 121, for example. The storage chamber 127RA may contain the lubricant 126 stored therein, for example. For example, part or all of the bent part 125B of the separation plate 125 may be positioned inside of the storage chamber 127RA, as described above. The storage chamber 127RA may correspond to a “first storage space” in one specific but non-limiting embodiment of the technology.

The storage chamber 127RB may be provided downstream of the containing chamber 127N in the moving direction D of the heating belt 122, i.e., between the protrusion 127PB and the heater 121, for example. The storage chamber 127RB may contain the lubricant 126 stored therein, for example. For example, part or all of the bent part 125C of the separation plate 125 may be positioned inside of the storage chamber 127RB, as described above. The storage chamber 127RB may correspond to a “second storage space” in one specific but non-limiting embodiment of the technology.

The lubricant 126 stored in the storage chamber 127RA may be fed to the gap between the heating belt 122 and the separation plate 125 to thereby improve slidability of the heating belt 122 against the separation plate 125. Similarly, the lubricant 126 stored in the storage chamber 127RB may be fed to the gap between the heating belt 122 and the separation plate 125 to thereby improve the slidability of the heating belt 122 against the separation plate 125. The heating belt 122 may thereby indirectly come into contact with the separation plate 125 with the lubricant 126 in between.

The lubricant 126 stored in the storage chamber 127RB may be attached to the inner surface of the ring-shaped heating belt 122. The heating belt 122 attached with the lubricant 126 may move in the moving direction D. The lubricant 126 stored in the storage chamber 127RB may thereby fed to the storage chamber 127RA in accordance with the moving of the heating belt 122. In other words, the heating belt 122 may also deliver the lubricant 126 from the storage chamber 127RB to the storage chamber 127RA.

In one example, a position of a tip of the protrusion 127PA and a position of a tip of the protrusion 127PB may be coincident with each other in the direction in which the heater 121 and the pressure-applying roller 131 are opposed to each other, i.e., in the Z-axis direction. As used herein, the wording “be coincident with” may encompass not only a completely-coincident state but also a substantially-coincident state. Hereinafter, a state where one position and another position is coincident with each other in the direction in which the heater 121 and the pressure-applying roller 131 are opposed to each other may be also simply referred to by a wording “one position and another position is coincident with each other” or its variants.

For example, the position of the tip of the protrusion 127PA may be coincident with a contact position of the heating belt 122 and the separation plate 125, i.e., a position at which the heating belt 122 and the separation plate 125 are in contact with each other. Accordingly, the protrusion 127PA may be in contact with the heating belt 122 at a position corresponding to the contact position of the heating belt 122 and the separation plate 125, for example. In this case, the protrusion 127PA may guide the heating belt 122 toward the nip 150 while supporting the heating belt 122.

For example, the position of the tip of the protrusion 127PB may be coincident with the contact position of the heating belt 122 and the separation plate 125, as with the position of the tip of the protrusion 127PA described above. Accordingly, the protrusion 127PB may be in contact with the heating belt 122 at a position corresponding to the contact position of the heating belt 122 and the separation plate 125, for example. In this case, the protrusion 127PB may guide the heating belt 122 toward outside of the heating device 100 while supporting the heating belt 122.

In the example described above, the position of the tip of the protrusion 127PA and the position of the tip of the protrusion 127PB may be coincident with each other. Therefore, a volume of the storage chamber 127RA and a volume of the storage chamber 127RB may be the same as or substantially the same as each other, for example. The volume of the storage chamber 127RA may be determined on the basis of a length by which the protrusion 127PA protrudes, i.e., a dimension of the protrusion 127PA in the Z-axis direction. The volume of the storage chamber 127RB may be determined on the basis of a length by which the protrusion 127PB protrudes, i.e., a dimension of the protrusion 127PB in the Z-axis direction.

### [Pressure-Applying Part]

The pressure-applying part 130 may include, for example but not limited to, a pressure-applying roller 131. The pressure-applying part 130 may extend, for example, in the Y-axis direction as with the heating part 120, as illustrated in FIG. 1. Accordingly, the pressure-applying roller 131 may also extend in the Y-axis direction. The pressure-applying roller 131 may correspond to a “pressure-applying member” in one specific but non-limiting embodiment of the technology.

The pressure-applying roller 131 may be a cylindrical member that is rotatable around a rotation axis J. The rotation axis J may extend in the X-axis direction. The pressure-applying roller 131 may be in contact with the separation plate 125 with the heating belt 122 in between, and thereby be in contact with the heater 121 with the eating belt 122 in between. This may provide the nip 150. For example, the pressure-applying roller 131 may be a coated roller including cylindrical core metal, an elastic layer, and a surficial layer. The elastic layer and the surficial layer may be stacked in this order on a surface of the cylindrical core metal. The cylindrical core metal may include, for example but not limited to, free-cutting steel (SUM). The elastic layer may include, for example but not limited to, silicon rubber. The surficial layer may include, for example but not limited to, a PFA tube. In a case where the pressure-applying roller 131 is brought into contact with the heating belt 122, each of the surficial layer and the elastic layer may be contracted and deformed as a result of being pressed against the heating belt 122. Accordingly, a contact surface on which the heating belt 122 and the pressure-applying roller 131 are in contact with each other may be provided, which may serve as the nip 150.

### [Other Components]

The heating device 100 may include one or more other components in addition to the series of components described above, for example. Non-limiting examples of the other components may include a controller that controls general operation of the heating device 100. The controller may include, for example but not limited to, a temperature adjusting circuit and a current feeding circuit. The temperature adjusting circuit may control a temperature of the heater 121 by means of the temperature sensor 123. The current feeding circuit may supply an electric current to the heater 121.

### [1-2. Operation]

The heating device 100 may operate as follows, for example. FIGS. 1 to 4 will be referred to where appropriate in the description below.

Upon heating of the heating target, the heating part 120 may move toward the pressure-applying part 130. The pressure-applying roller 131 may be thereby brought into contact with the heating belt 122, whereby the nip 150 may be provided. Further, the heating target may be fed along the feeding path P. The heating target may thereby move from the upstream region of the nip 150 toward the downstream region of the nip 150. The heating target may therefore pass between the heating belt 122 and the pressure-applying roller 131.

In this case, when the heater 121 generates heat, the heat generated by the heater 121 may be transferred to the heating belt 122 via the separation plate 125. Therefore, the heating belt 122 may be heated. Thereby, the heating target may be heated by the heating belt 122 while being applied with pressure by the pressure-applying roller 131.

In an example case where the heating target is applied with pressure and also heated, the heating belt 122 may move in the moving direction D while sliding against the separation plate 125. Therefore, the heating target may be continuously applied with pressure and continuously heated. In this case, the lubricant 126 stored in each of the storage chamber 127RA and the storage chamber 127RB may be fed to the gap between the heating belt 122 and the separation plate 125. Therefore, the heating belt 122 may slide smoothly by means of the lubricant 126.

### [1-3. Example Workings and Example Effects]

In the heating device 100, the separation plate 125 may be disposed between the heater 121 and the heating belt 122. The separation plate 125 may include the inclined part 125D in the upstream region of the nip 150. Therefore, an improved heating characteristic is obtainable for the following reasons.

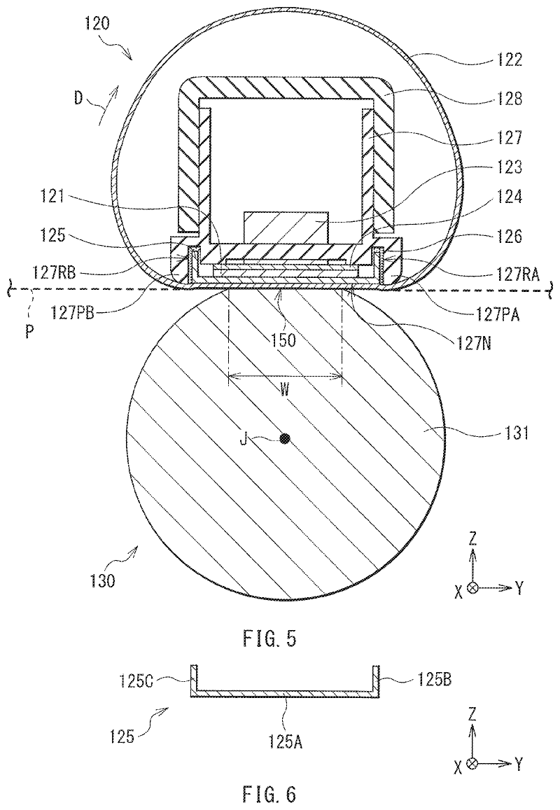

FIG. 5 illustrates a cross-sectional configuration of a main part of a heating device according to a comparative example, and corresponds to FIG. 2. FIG. 6 illustrates a cross-sectional configuration of the separation plate 125 illustrated in FIG. 5, and corresponds to FIG. 4. The heating device according to the comparative example has a configuration similar to that of the heating device 100 according to the first example embodiment of the technology, except that the separation plate 125 of the heating device according to the comparative example does not include the inclined part 125D and therefore include only the flat part 125A and the pair of the bent parts, i.e., the bent part 125B and the bent part 125C.

As illustrated in FIGS. 5 and 6, the separation plate 125 of the heating device according to the comparative example does not include the inclined part 125D. Therefore, the storage chamber 127RA may be defined substantially by the protrusion 127PA and the bent part 125B. In this case, the storage chamber 127RA may correspond to a smaller space provided between the protrusion 127PA and the bent part 125B. Therefore, the volume of the storage chamber 127RA is smaller.

Due to the above-described configuration, firstly, the amount of the lubricant 126 stored in the storage chamber 127RA is insufficient. Therefore, it is more difficult to feed a sufficient amount of lubricant 126 from the storage chamber 127RA to the gap between the heating belt 122 and the separation plate 125. Accordingly, it is easier for the heating belt 122 to be worn when the heating belt 122 slides against the separation plate 125.

Secondly, the lubricant 126 comes into contact only with the bent part 125B. Therefore, the area by which the lubricant 126 is in contact with the separation plate 125 is insufficient. In this case, when the separation plate 125 is heated with the heat generated by the heater 121, the lubricant 126 receives heat only from the bent part 125B. Therefore, it is more difficult to heat the lubricant 126 sufficiently. Accordingly, a viscosity of the lubricant 126 is higher than that of the lubricant 126 of the heating device 100 according to the first example embodiment. The viscosity of the lubricant 126 of the heating device 100 according to the first example embodiment will be described later. Therefore, it is more difficult to supply the lubricant 126 from the storage chamber 127RA to the gap between the heating belt 122 and the separation plate 125.

Thirdly, an area by which the lubricant 126 is in contact with the heating belt 122 is insufficient. Therefore, it is more difficult for the lubricant 126 to be attached to the inner surface of the heating belt 122. Accordingly, it is easier for the heating belt 122 to be worn when the heating belt 122 slides against the separation plate 125.

As described above, in the heating device according to the comparative example, when the heating target is heated, it is more difficult for the heating belt 122 to slide smoothly by means of the lubricant 126, and it is easier for the heating belt 122 to be worn. Therefore, load torque increases when the heating belt 122 slides. In this case, an abnormal noise is generated more easily due to the increase in load torque when the heating belt 122 slides. Accordingly, it is more difficult to stably heat the heating target by means of the heating belt 122. It is therefore more difficult to obtain a superior heating characteristic.

In contrast, in the heating device 100 according to the first example embodiment, the separation plate 125 includes the inclined part 125D, as illustrated in FIGS. 2 and 4. Therefore, the storage chamber 127RA may be defined substantially by the protrusion 127PA, the bent part 125B, and also the inclined part 125D. In this case, the storage chamber 127RA may correspond not only to the smaller space provided between the protrusion 127PA and the bent part 125B, but also to the additional space provided between the protrusion 127PA and the inclined part 125D. Therefore, the volume of the storage chamber 127RA may be greater. Accordingly, the volume of the storage chamber 127RA of the heating device 100 according to the first example embodiment may be greater than the volume of the storage chamber 127RA of the heating device according to the comparative example.

In this case, firstly, the amount of the lubricant 126 stored in the storage chamber 127RA increases. Therefore, it is easier to feed a sufficient amount of lubricant 126 from the storage chamber 127RA to the gap between the heating belt 122 and the separation plate 125. Accordingly, it is more difficult for the heating belt 122 to be worn when the heating belt 122 slides.

Secondly, the lubricant 126 may come into contact not only with the bent part 125B but also with the inclined part 125D. Therefore, the area by which the lubricant 126 is in contact with the separation plate 125 increases. In this case, when the separation plate 125 is heated with the heat generated by the heater 121, the lubricant 126 may receive heat not only from the bent part 125B but also from the inclined part 125D. Therefore, it is easier to heat the lubricant 126 sufficiently. Accordingly, the viscosity of the lubricant 126 according to the first example embodiment may be lower than that of the lubricant 126 of the heating device according to the comparative example described above. Therefore, it is easier to feed the lubricant 126 from the storage chamber 127RA to the gap between the heating belt 122 and the separation plate 125.

Thirdly, the area by which the lubricant 126 is in contact with the heating belt 122 increases. Therefore, it is easier for the lubricant 126 to be attached to the inner surface of the heating belt 122. Accordingly, it is more difficult for the heating belt 122 to be worn when the heating belt 122 slides.

As described above, in the heating device 100 according to the first example embodiment, when the heating target is heated, it is easier for the heating belt 122 to slide smoothly by means of the lubricant 126, and it is more difficult for the heating belt 122 to be worn. Therefore, load torque decreases when the heating belt 122 slides. In this case, owing to the decrease in load torque, it is more difficult for an abnormal noise to be generated when the heating belt 122 slides. Accordingly, it is easier to stably heat the heating target by means of the heating belt 122. Hence, it is possible to obtain an improved heating characteristic.

For example, in a case where the separation plate 125 includes the separation plate 125 in the upstream region of the nip 150, the volume increases of the storage chamber 127RA disposed on the side of the nip 150 toward which the heating belt 122 moves, i.e., on the front side of the nip 150. The volume of the storage chamber 127RA may correspond to the stored amount of the lubricant 126. In this case, a sufficient amount of lubricant 126 may be provided at a position where the contact between the heating belt 122 and the separation plate 125 starts and in the vicinity thereof. Therefore, it is further easier for the heating belt 122 to slide by means of the lubricant 126 and it is further more difficult for the heating belt 122 to be worn. Hence, it is possible to obtain a higher effect.

In a case where the separation plate 125 is a heat diffusing member that diffuses the heat generated by the heater 121, the heating belt 122 may be heated efficiently with the heat diffused by the separation plate 125. Accordingly, it is more difficult for temperature unevenness to occur on the heating belt 122. Hence, it is possible to obtain a higher effect.

On a condition that: the supporting member 127 includes the pair of protrusions, i.e., the protrusion 127PA and the protrusion 127PB; and the heater 121 and the separation plate 125 are disposed between the protrusion 127PA and the protrusion 127PB, the storage chamber 127RA may be provided between the protrusion 127PA and the heater 121. Further, the storage chamber 127RB may be provided between the protrusion 127PB and the heater 121. Therefore, the lubricant 126 may be stored in each of the storage chamber 127RA and the storage chamber 127RB. Further, the lubricant 126 may be stably fed from each of the storage chamber 127RA and the storage chamber 127RB to the gap between the heating belt 122 and the separation plate 125. Hence, it is possible to obtain a higher effect.

### 2. Heating Device (Second Example Embodiment)

A description is given next of a heating device according to a second example embodiment of the technology.

### [2-1. Configuration]

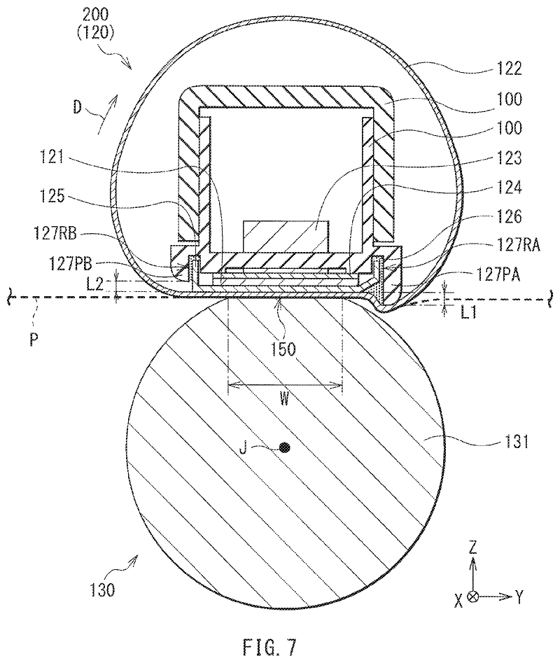

FIG. 7 illustrates a cross-sectional configuration of a heating device 200 which is an example of the heating device according to one embodiment of the technology. FIG. 7 corresponds to FIG. 2. The configuration of the heating device 200 may be similar to that of the heating device 100 described above except for the following respects. The heating device 100 described above will be referred to where appropriate in the description below.

For example, the position of the tip of the protrusion 127PA and the position of the tip of the protrusion 127PB may be different from each other in the direction in which the heater 121 and the pressure-applying roller 131 are opposed to each other, i.e., in the Z-axis direction. In other words, the position of the tip of the protrusion 127PA and the position of the tip of the protrusion 127PB may be shifted from each other in the Z-axis direction.

In one example, the protrusion 127PA may be so positioned at a more-frontward position that the protrusion 127PA is closer to the pressure-applying part 130, compared to a position corresponding to the contact position of the heating belt 122 and the separation plate 125 as a reference. Hereinafter, the position corresponding to the contact position of the heating belt 122 and the separation plate 125 may be also simply referred to as a “reference position”. In another example, the protrusion 127PA may be so positioned at a more-rearward position that the protrusion 127PA is away from the pressure-applying part 130, compared with the reference position. A distance L1 in the Z-axis direction from the tip of the protrusion 127PA to a contact surface of the heating belt 122 against the separation plate 125 may be expressed by a positive value in a case where the protrusion 127PA is positioned at a more-frontward position compared with the reference position. The contact surface of the heating belt 122 against the separation plate 125 may be a surface on which the heating belt 122 is in contact with the separation plate 125, and may be also referred to as a slide surface of the heating belt 122 against the separation plate 125. The distance L1 may be expressed by a negative value in a case where the protrusion 127PA is positioned at a more-rearward position compared with the reference position.

In the case where the protrusion 127PA is positioned at a more-frontward position compared with the reference position, the tip of the protrusion 127PA may be positioned closer to the pressure-applying roller 131 than to the separation plate 125, i.e., positioned on the lower side in FIG. 7, for example. Therefore, the protrusion 127PA may be in contact with the heating belt 122 at a position that is closer to the pressure-applying roller 131 than to the separation plate 125, for example. Accordingly, the heating belt 122 may be curved along the tip of the protrusion 127PA and thereby guided toward the nip 150 by the protrusion 127PA.

In the case where the protrusion 127PA is positioned at a more-rearward position compared with the reference position, the tip of the protrusion 127PA may be positioned closer to the separation plate 125 than to the pressure-applying roller 131, i.e., positioned on the upper side in FIG. 7, for example. Therefore, the protrusion 127PA may not be in contact with the heating belt 122, for example. Accordingly, the heating belt 122 may be guided toward the nip 150 without being supported by the protrusion 127PA.

The distance L1 is not particularly limited. In one example, the distance L1 may be in a range from −0.3 mm to +0.3 mm, both inclusive. One reason for this may be that it is more difficult for the load torque to increase when the heating belt 122 slides, and it is therefore easier for the heating belt 122 to move smoothly and stably when the distance L1 is in the foregoing range. It is to be noted that FIG. 7 illustrates a case where the distance L1 has a positive value as the protrusion 127PA is positioned at a more-frontward position compared with the reference position.

In this case, when the distance L1 is excessively great, the heating belt 122 may be deformed excessively. For example, the heating belt 122 may be brought in a so-called reversely-curved state. This can decrease durability of the heating belt 122 such as a fatigue state of the heating belt 122.

In contrast, when the distance L1 is excessively small, the heating belt 122 may directly come into contact with the separation plate 125 without the lubricant 126 in between, which makes it easier for the heating belt 122 to be worn. When it is easier for the heating belt 122 to be worn, wear debris of the heating belt 122 may be mixed into the lubricant 126. As a result, the viscosity of the lubricant 126 may increase. Accordingly, the load torque may increase when the heating belt 122 slides. Therefore, an abnormal noise can be generated due to the increase in load torque.

As with the protrusion 127PA described above, in one example, the protrusion 127PB may be so positioned at a more-frontward position that the protrusion 127PB is closer to the pressure-applying part 130, compared with the reference position. In another example, the protrusion 127PB may be so positioned at a more-rearward position that the protrusion 127PB is away from the pressure-applying part 130, compared with the reference position. As with the distance L1 described above, a distance L2 in the Z-axis direction from the tip of the protrusion 127PB to the slide surface of the heating belt 122 may be expressed by a positive value in a case where the protrusion 127PB is positioned at a more-frontward position compared with the reference position. The distance L2 may be expressed by a negative value in a case where the protrusion 127PB is positioned at a more-rearward position compared with the reference position.

In the case where the protrusion 127PB is positioned at a more-frontward position compared with the reference position, the tip of the protrusion 127PB may be positioned closer to the pressure-applying roller 131 than to the separation plate 125, for example. Therefore, the protrusion 127PB may be in contact with the heating belt 122 at a position that is closer to the pressure-applying roller 131 than to the separation plate 125, for example. Accordingly, the heating belt 122 may be curved along the tip of the protrusion 127PB and thereby guided by the protrusion 127PB toward the nip 150 again.

In the case where the protrusion 127PB is positioned at a more-rearward position compared with the reference position, as with the tip of the protrusion 127PA described above, the tip of the protrusion 127PB may be positioned closer to the separation plate 125 than to the pressure-applying roller 131, for example. Therefore, the protrusion 127PB may not be in contact with the heating belt 122, for example. Accordingly, the heating belt 122 may be guided toward the nip 150 again without being supported by the protrusion 127PB.

The distance L2 is not particularly limited. In one example, the distance L2 may be in a range from −0.3 mm to +0.3 mm, both inclusive. One reason for this may be similar to that described above concerning the distance L1. It is to be noted that FIG. 7 illustrates a case where the distance L2 has a negative value as the protrusion 127PB is positioned at a more-rearward position compared with the reference position.

In one example, as the protrusion 127PA may be so positioned at a more-frontward position that the protrusion 127PA is closer to the pressure-applying part 130 compared with the reference position, the tip of the protrusion 127PA may be positioned closer to the pressure-applying roller 131 than to the separation plate 125. One reason for this may be that the volume of the storage chamber 127RA may increase compared with that in the case where the protrusion 127PA is not positioned at the more-frontward position. Accordingly, it is easier for a greater amount of lubricant 126 to be fed from the storage chamber 127RA to the gap between the heating belt 122 and the separation plate 125.

In one example, as the protrusion 127PB may be so positioned at a more-rearward position that the protrusion 127PB is away from the pressure-applying part 130 compared with the reference position, the tip of the protrusion 127PB may be positioned closer to the separation plate 125 than to the pressure-applying roller 131. One reason for this may be that the volume of the storage chamber 127RB may decrease compared to that in the case where the protrusion 127PB is not positioned at the more-rearward position. In this case, it is easier for the lubricant 126 to circulate from the storage chamber 127RB having the smaller volume to the storage chamber 127RA having the greater volume. Therefore, it is easier for a sufficient amount of lubricant 126 to be stored in the storage chamber 127RA having the greater volume. Accordingly, it is easier for a greater amount of lubricant 126 to be fed from the storage chamber 127RA to the gap between the heating belt 122 and the separation plate 125.

For example, on a condition that: the protrusion 127PA is so positioned at a more-frontward position that the protrusion 127PA is closer to the pressure-applying part 130 compared with the reference position; and the protrusion 127PB is so positioned at a more-rearward position that the protrusion 127PB is away from the pressure-applying part 130 compared with the reference position, the volume of the storage chamber 127RA may be greater than the volume of the storage chamber 127RB.

In a case where the protrusion 127PA is positioned at a more-frontward position or a more-rearward position compared with the reference position, the protrusion 127PB may not be positioned at a more-frontward position or a more-rearward position compared with the reference position. Therefore, the position of the tip of the protrusion 127PB may be coincident with the position of the slide surface of the heating belt 122. In other words, in a case where the distance L1 has a positive value or a negative value, the distance L2 may be zero (±0 mm) or substantially zero.

In a case where the protrusion 127PB is positioned at a more-frontward position or a more-rearward position compared with the reference position, the protrusion 127PA may not be positioned at a more-frontward position or a more-rearward position compared with the reference position. Therefore, the position of the tip of the protrusion 127PA may be coincident with the position of the slide surface of the heating belt 122. In other words, in a case where the distance L2 has a positive value or a negative value, the distance L1 may be zero (±0 mm) or substantially zero.

### [2-2. Operation]

For example, operation of the heating device 200 may be similar to that of the heating device 100 except that the position of the tip of the protrusion 127PA and the position of the tip of the protrusion 127PB are different from each other in the direction in which the heater 121 and the pressure-applying roller 131 are opposed to each other, and therefore the moving path of the heating belt 122 is varied.

As illustrated in FIG. 7, for example, on a condition that: the protrusion 127PA is so positioned at a more-frontward position that the protrusion 127PA is closer to the pressure-applying part 130 compared with the reference position; and the protrusion 127PB is so positioned at a more-rearward position that the protrusion 127PB is away from the pressure-applying part 130 compared with the reference position, the heating belt 122 may move while being supported by the protrusion 127PA, and may move without being supported by the protrusion 127PB.

### 2-3. Example Workings and Example Effects

In the heating device 200, the separation plate 125 may be provided that includes the inclined part 125D in the upstream region of the nip 150. Therefore, an improved heating characteristic is obtainable for a reason similar to that described above concerning the heating device 100.

In one example, the protrusion 127PA may be so positioned at a more-frontward position that the protrusion 127PA is closer to the pressure-applying part 130 compared with the reference position. Therefore, when the tip of the protrusion 127PA is positioned closer to the pressure-applying roller 131 than to the separation plate 125, the volume of the storage chamber 127RA may increase. Accordingly, a greater amount of lubricant 126 may be fed from the storage chamber 127RA to the gap between the heating belt 122 and the separation plate 125. Hence, it is possible to obtain a higher effect.

In one example, the protrusion 127PB may be so positioned at a more-rearward position that the protrusion 127PB is away from the pressure-applying part 130 compared with the reference position. Therefore, when the tip of the protrusion 127PB is positioned closer to the separation plate 125 than to the pressure-applying roller 131, the volume of the storage chamber 127RB may decrease. Accordingly, it may be easier for the lubricant 126 to circulate from the storage chamber 127RB having the smaller volume to the storage chamber 127RA having the greater volume. Therefore, it may be easier for a sufficient amount of lubricant 126 to be stored in the storage chamber 127RA having the greater volume. A greater amount of lubricant 126 may be therefore fed from the storage chamber 127RA to the gap between the heating belt 122 and the separation plate 125. Hence, it is possible to obtain a higher effect.

It is to be noted that, considering a start amount of the lubricant 126 more than an end amount of the lubricant 126 helps to make it easier to allow the heating belt 122 to slide smoothly and stably. The start amount of the lubricant 126 may be the amount of the lubricant 126 provided in the vicinity of the position where contact between the heating belt 122 and the separation plate 125 starts. The end amount of the lubricant 126 may be the amount of the lubricant 126 provided in the vicinity of the position where the contact between the heating belt 122 and the separation plate 125 ends. One reason for this may be that the influence of the end amount of the lubricant 126 may be small on the slidability of the heating belt 122; however, the influence of the start amount of the lubricant 126 may be greater on the slidability of the heating belt 122. Accordingly, the slidability of the heating belt 122 may be improved by increasing the volume of the storage chamber 127RA on which the start amount of the lubricant 126 depends. In contrast, it is less likely that a decrease in volume of the storage chamber 127RB on which the end amount of the lubricant 126 depends decreases the slidability of the heating belt 122.

Other example workings and other example effects related to the heating device 200 may be similar to those related to the heating device 100.

### 3. Modification Examples

The configuration of any of the heating devices described above may be appropriately modified. It is to be noted that any two or more of the series of modification examples described below may be applied in combination.

For example, the separation plate 125 may include the inclined part 125D only in the upstream region of the nip 150 in the heating units described above.

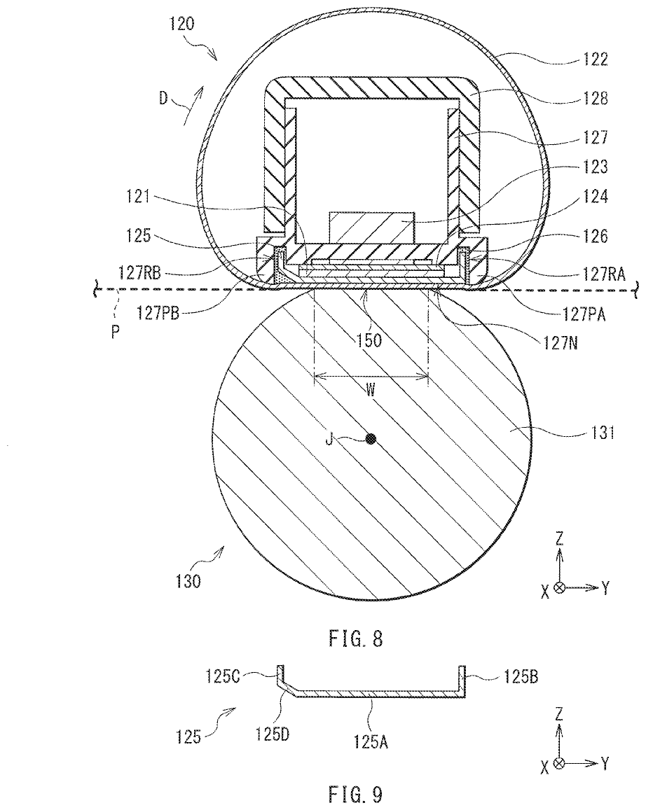

However, according to Modification example 1, as illustrated in FIGS. 8 and 9 respectively corresponding to FIGS. 2 and 4, the separation plate 125 may include the inclined part 125D in the downstream region of the nip 150, for example. The amount of the lubricant 126 stored in the storage chamber 127RB may increase also in this case compared with the case where the separation plate 125 does not include the inclined part 125D. Hence, it is possible to obtain an effect similar to that of the example embodiments described above. In this case, for example, the increase in the amount of the lubricant 126 stored in the storage chamber 127RB may increase the amount of the lubricant 126 to be fed from the storage chamber 127RB to the storage chamber 127RA in accordance with the moving of the heating belt 122. Therefore, it is easier for a sufficient amount of the lubricant 126 to be fed to the storage chamber 127RA.

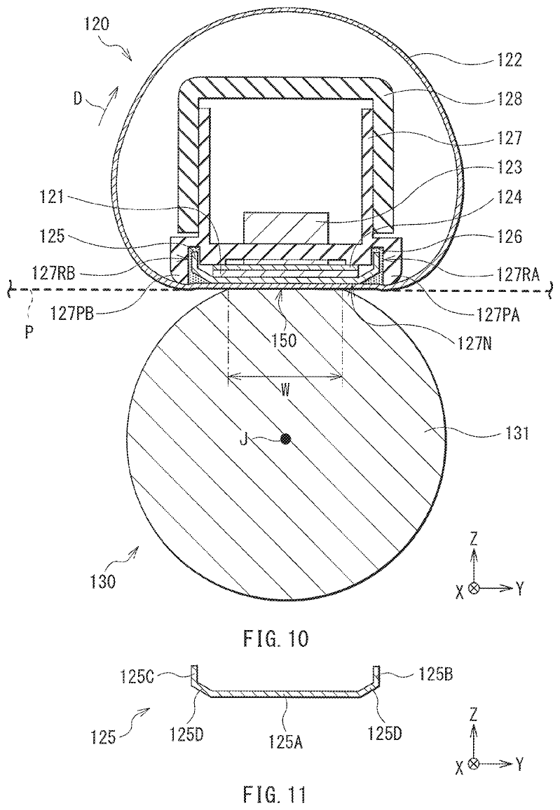

According to Modification example 2, as illustrated in FIGS. 10 and 11 respectively corresponding to FIGS. 2 and 4, the separation plate 125 may include the inclined part 125D in the upstream region of the nip 150 and also include the inclined part 125D in the downstream region of the nip 150. The amount of the lubricant 126 stored in each of the storage chambers 127RA and 127RB may increase also in this case compared with the case where the separation plate 125 does not include the inclined part 125D. Hence, it is possible to obtain an effect similar to that of the example embodiments described above.

However, as described above, in order to effectively improve the slidability of the heating belt 122, the separation plate 125 may include the inclined part 125D in the upstream region of the nip 150, whereby increasing the volume of the storage chamber 127RA, in one example.

As described above, in order to increase the amount of the lubricant 126 stored in the storage chamber 127RA, the separation plate 125 may not include the inclined part 125D in the downstream region of the nip 150, whereby intentionally decreasing the volume of the storage chamber 127RB, in one example.

Taking into consideration the matters described above, in order to remarkably improve the slidability of the heating belt 122 by increasing the volume of the storage chamber 127RA and decreasing the volume of the storage chamber 127RB, the separation plate 125 may include the inclined part 125D only in the upstream region of the nip 150 in one example, as illustrated in FIG. 2.

### 4. Image Forming Apparatus

A description is given next of an image forming apparatus according to one example embodiment using any of the heating devices described above. The heating device 100, the heating device 200, the components of the heating device 100, and the components of the heating device 200 that have been already described above will be referred to where appropriate in the description below.

As will be described later, the image forming apparatus may form an image on a print medium M illustrated in FIG. 12 with the use of a toner. The image forming apparatus may be a so-called electrophotographic full-color printer. The print medium M is not particularly limited in its type. For example, the print medium M may include one or more of printable media such as paper or a film.

A series of rollers described below, i.e., a series of components having a name including a term “roller”, may each be a cylindrical member that extends in the Y-axis direction and rotatable around a rotation axis that extends in the Y-axis direction.

### [4-1. Configuration]

FIG. 12 illustrates a planar configuration of the image forming apparatus. The image forming apparatus may include a fixing section 30 to which any of the heating devices described above is applied.

For example, as illustrated in FIG. 12, the image forming apparatus may include, inside a housing 1, a tray T, a developing section 10, a transfer section 20, the fixing section 30, various rollers, and a switching guide 60. The various rollers may include, for example but not limited to, a pick-up roller 41, a print medium feeding roller 42, a separating roller 43, a registration roller 44, a pressure roller 45, and conveying rollers 46 to 53. The tray T may contain a plurality of print media M in a stacked state, for example. The housing 1 may be provided with a stacker 2 to which the print medium M formed with an image is to be discharged, for example.

For example, the image forming apparatus described below may be able to form an image on one side of the print medium M and also able to form images on both sides of the print medium M, by switching a conveying direction of the print medium M by means of the switching guide 60. The conveying direction of the print medium M may be a direction in which the print medium M is to be conveyed. In a case where the image forming apparatus forms an image on one side of the print medium M, the image may be formed on a front surface of the print medium M, for example. In a case where the image forming apparatus forms images on both sides of the print medium M, the images may be formed on each of the front surface and a back surface of the print medium M, for example.

In the image forming apparatus, the print medium M may be conveyed in a conveyance direction H in each of conveyance routes R1 to R4 indicated by dashed lines. The conveyance route R1 may be a route along which the print medium M is to be conveyed from the tray T toward the developing section 10 and the transfer section 20. The conveyance route R2 may be a route along which the print medium M is to be conveyed from the developing section 10 and the transfer section 20 toward the fixing section 30 when an image is to be formed on one side of the print medium M, i.e., on the front surface of the print medium M. The conveyance route R3 may be a route along which the print medium M is to be conveyed from the fixing section 30 toward the stacker 2. The conveyance route R4 may be a diverting route along which the print medium M is to be conveyed from the fixing section 30 toward the developing section 10 and the transfer section 20 again to thereby form an image on the back surface of the print medium M when images are to be formed on both sides of the print medium M.

### [Developing Section]

The developing section 10 may perform a developing process with the use of a toner. For example, the developing section 10 may form an electrostatic latent image, and attach the toner to the electrostatic latent image by utilizing Coulomb force.

The developing section 10 may include a developing process unit 11 and an exposure process unit 12, for example. The developing process unit 11 may perform a developing process. The exposure process unit 12 may perform an exposure process. The developing process unit 11 may include a photosensitive drum 13 on which an electrostatic latent image is to be formed. The developing process unit 11 may be attachable to and detachable from the housing 1. The photosensitive drum 13 may be a cylindrical member that extends in the Y-axis direction. The photosensitive drum 13 may be rotatable around a rotation axis that extends in the Y-axis direction. The exposure process unit 12 may be provided together with the developing process unit 11. The exposure process unit 12 may form an electrostatic latent image on a surface of the photosensitive drum 13. The exposure process unit 12 may include, for example but not limited to, a light-emitting diode (LED) device.

In this example, the developing section 10 may include four developing process units 11 and four exposure process units 12. The four developing process units 11 may be developing process units 11K, 11Y, 11M, and 11C. The four exposure process units 12 may be exposure process units 12K, 12Y, 12M, and 12C. The developing process units 11K, 11Y, 11M, and 11C may be disposed in this order in the conveyance direction H, for example. The exposure process units 12K, 12Y, 12M, and 12C may be disposed in order similar to the disposing order of the developing process units 11K, 11Y, 11M, and 11C, for example.

The developing process units 11K, 11Y, 11M, and 11C may have configurations similar to each other, except that the types, e.g., the colors, of the toners to be used in the developing process are different from each other, for example. For example, the developing process units 11K, 11Y, 11M, and 11C may be mounted with a black toner, a yellow toner, a magenta toner, and a cyan toner, respectively.

### [Transfer Section]

The transfer section 20 may perform a transfer process with the use of the toner that has been subjected to the developing process by the developing section 10. For example, the transfer section 20 may transfer, onto the print medium M being conveyed in the conveyance direction H, the toner that has been attached to the electrostatic latent image by the developing section 10.

The transfer section 20 may include, for example but not limited to, a drive roller 21, an idle roller 22, a transfer belt 23, and a transfer roller 24.

The drive roller 21 may be rotatable by means of a drive source such as a motor, for example. The idle roller 22 may be rotatable in accordance with rotation of the drive roller 21, for example. The transfer belt 23 may be an endless belt, for example. The transfer belt 23 may lie on the drive roller 21, the idle roller 22, and the transfer roller 24 while being stretched, for example. The transfer belt 23 may be movable in accordance with the rotation of the drive roller 21 in such a state.

The transfer roller 24 may be in contact with the developing process unit 11 or the photosensitive drum 13 with the transfer belt 23 in between. In this example, the transfer section 20 may include four transfer rollers 24, i.e., transfer rollers 24K, 24Y, 24M, and 24C. The transfer rollers 24K, 24Y, 24M, and 24C may be disposed in order similar to the disposing order of the developing process units 11K, 11Y, 11M, and 11C, for example.

### [Fixing Section]

The fixing section 30 may have a configuration similar to that of any of the heating devices described above. The fixing section 30 may have a configuration similar to that of the heating device 100 in one example. The fixing section 30 may have a configuration similar to that of the heating device 200 in another example. The fixing section 30 may have a configuration applied with any of the modification examples described above.

The fixing section 30 may perform a fixing process with the use of the toner transferred onto the print medium M by the transfer section 20. For example, the fixing section 30 may fix the toner to the print medium M by applying pressure on the print medium M onto which the toner has been transferred by the transfer section 20, while heating the print medium M. The print medium M may serve as the heating target. In this case, the heating belt 122 may serve as a fixing belt. It is to be noted that illustration of the fixing section 30 is simplified in FIG. 12.

### [Various Rollers and Switching Guide]

The pick-up roller 41 may pick up the print medium M from the tray T. The print medium feeding roller 42 may guide the print medium M, which has been picked up from the tray T by the pick-up roller 41, from the conveyance route R1 to the conveyance route R2. The separating roller 43 may separate, when a plurality of print media M has been picked up from the tray T, the print medium M on the top from the rest of the print media M. The registration roller 44 and the pressure roller 45 may correct a skew of the print medium M. Each of the conveying rollers 46 to 53 may include a pair of rollers that are opposed to each other with the corresponding one of the conveyance routes R2 to R4 in between. Each of the conveying rollers 46 to 53 may convey the print medium M along the corresponding one of the conveyance routes R2 to R4. The conveying roller 48 may be a discharging roller that discharges, to the stacker 2, the print medium M on which an image has been formed.

The switching guide 60 may be disposed downstream of the fixing section 30 in the conveyance direction H. The switching guide 60 may switch the conveyance direction of the print medium M on the basis of an image formation mode. In a case where an image is to be formed only on one side of the print medium M, i.e., only on the front surface of the print medium M, the switching guide 60 may convey the print medium M along the conveyance routes R2 and R3, for example. In a case where images are to be formed on both sides of the print medium M, i.e., on the front surface and the back surface of the print medium M, the switching guide 60 may convey the print medium M along the conveyance routes R2 to R4, for example.

### [4-2. Operation]

In a case where an image is to be formed on the print medium M, the image forming apparatus may perform the developing process, the transfer process, and the fixing process in this order as described below, for example.

First, the print medium M contained in the tray T may be picked up by the pick-up roller 41. Thereafter, the print medium M may be conveyed along the conveyance routes R1 and R2. Thereafter, as the developing process, an electrostatic latent image may be formed on the surface of the photosensitive drum 13 by the developing section 10, following which the toner may be attached to the electrostatic latent image. Thereafter, as the transfer process, the toner attached to the electrostatic latent image may be transferred onto the print medium M by the transfer section 20. Thereafter, as the fixing process, the toner transferred onto the print medium M may be applied with heat and pressure by the fixing section 30. The toner may be thereby fixed to the print medium M, whereby an image may be formed on the print medium M. The print medium M on which an image has been formed may be discharged to the stacker 2. The type, e.g., the color or the number, of the toner to be used in image formation may be determined on the basis of a combination of colors necessary to form the relevant image.

### [4-3. Example Workings and Example Effects]

In the image forming apparatus, the fixing section 30 may have a configuration similar to that of any of the heating devices described above. Therefore, an improved heating characteristic is obtainable in the fixing section 30. Accordingly, the toner may be stably fixed to the print medium M by the fixing section 30, which allows for stable image formation on the print medium M. Other example workings and other example effects may be similar to those of any of the heating devices described above.

### WORKING EXAMPLES

Some working examples according to one example embodiment of the technology will be described in detail.

### Experiment Examples 1 to 5

As will be described below, the heating device 200 illustrated in FIGS. 4 and 7 was prepared as an example of the heating devices described above. Thereafter, a heating characteristic of the prepared heating device 200 was evaluated.

### [Preparation of Heating Device]

The heating device 200 having the following configuration was prepared. As the heater 121, a three-system planar heater was used. As the heating belt 122, an endless belt having a stack structure including a surficial layer (a PFA tube having a thickness of 20 μm), an elastic layer (silicon rubber having a thickness of 300 μm), and a base material (SUS having a thickness of 30 μm) in this order was used. The endless belt had an outer diameter of 30 mm. As the separation plate 125 including the inclined part 125D, a metal plate (SUS having a thickness of 0.6 mm) coated with glass having a thickness of 20 μm was used. The separation plate 125 served as the heat diffusing plate. As the lubricant 126, fluorinated-polyether-based special grease (Molykote HP-300 Grease available from Dow Corning Toray Co., Ltd., located in Tokyo, Japan) was used. As the pressure-applying roller 131, a roller having a coated structure including a surficial layer (a PFA tube having a thickness of 30 μm), an elastic layer (silicon rubber having a thickness of 3 mm), and core metal (SUM) in this order was used. The roller had an outer diameter of 30 mm, an inverted crown of 0.2 mm, and Vickers hardness of 58±3 degrees. The nip 150 had a load of about 30 kgf and had a nip width in a range from about 9 mm to about 10 mm, both inclusive.

In this case, the shape of the protrusion 127PB was fixed, whereby the distance L2 was fixed at 0 (zero) mm. In contrast, the shape of the protrusion 127PA was varied, whereby the distance L1 was varied as described in Table 1. In a case where the distance L1 is 0 (zero) mm, the position of the tip of the protrusion 127PA and the position of the slide surface of the heating belt 122 are coincident with each other in the Z-axis direction. In a case where the distance L1 is greater than 0 (zero) mm, the protrusion 127PA is so disposed at a more-frontward position that the protrusion 127PA is closer to the pressure-applying part 130 in the Z-axis direction compared with the reference position. Therefore, the tip of the protrusion 127PA is positioned closer to the pressure-applying roller 131 than to the separation plate 125. In a case where the distance L1 is smaller than 0 (zero) mm, the protrusion 127PB is so disposed at a more-rearward position that the protrusion 127PB is away from the pressure-applying part 130 in the Z-axis direction compared with the reference position. Therefore, the tip of the protrusion 127PB is positioned closer to the separation plate 125 than to the pressure-applying roller 131.

### [Evaluation of Heating Characteristic]

A heating characteristic of the heating device 200 was examined and results were obtained as described in Table 1. The heating characteristic of the heating device 200 involved a moving characteristic of the heating belt 122, durability of the heating belt 122, and a silent characteristic of the heating belt 122.

### [Moving Characteristic]

As examination of the moving characteristic of the heating belt 122, load torque (kgf·cm) at the time of sliding of the heating belt 122 was measured by conducting an idling test on the heating device 200 by means of a continuous testing machine. The continuous testing machine included a temperature adjuster and a driving motor. The temperature adjuster controlled the temperature of the heater 121 of the heating device 200. The driving motor was coupled to the heating belt 122 of the heating device 200 via a torque meter. Upon conducting the idling test on the heating device 200, the heating belt 122 was moved by means of the driving motor while the temperature of the heater 121 was controlled to be constant by means of the temperature adjuster, whereby the load torque was measured by means of the torque meter. In this case, a heat generation temperature of the heater 121 was set to 160° C., and a rotation speed of the driving motor was set to 162 mm/sec. Further, an operation condition of the driving motor was so set that the driving motor repeatedly performed driving operation. The driving operation involved twenty-four-second driving and two-second stopping after the driving.

After measuring the load torque, the moving characteristic was determined on the basis of a measured value of the load torque. A case was determined as “A” where the load torque was smaller than 5 kgf·cm. A case was determined as “B” where the load torque was equal to or greater than 5 kgf·cm.

### [Durability]

As examination of the durability of the heating belt 122, after the idling test described above was conducted, the heating belt 122 was detached from the heating device 200 and a fatigue state of the heating belt 122 was visually checked. Thereby, the durability of the heating belt 122 was determined on the basis of the fatigue state of the heating belt 122.

A case was determined as “A” where the heating belt 122 had no fatigue as a result of being in contact with the protrusion 127PA and it was therefore easier to return the shape of the heating belt 122 to the original state. In contrast, a case was determined as “B” where the heating belt 122 had more fatigue as a result of being in contact with the protrusion 127PA and it was more difficult to return the shape of the heating belt 122 to the original state.

### [Silent Characteristic]

As examination of the silent characteristic, a state of occurrence of an abnormal sound due to sliding of the heating belt 122 upon the idling test described above was checked, whereby the silent characteristic was determined on the basis of the state of occurrence of the abnormal sound.

A case was determined as “A” where the abnormal sound did not occur as a result of the sliding of the heating belt 122. In contrast, a case was determined as “B” where the abnormal sound occurred as a result of the sliding of the heating belt 122.

TABLE 1

| | Distance L1 | Load torque | Fatigue of | Abnormal |
|---|---|---|---|---|
| | (mm) | (kgf · cm) | heating belt | sound |
| Experiment | +0.6 | B | B | A |
| example 1 | | | | |
| Experiment | +0.3 | A | A | A |
| example 2 | | | | |
| Experiment | 0 | A | A | A |
| example 3 | | | | |
| Experiment | −0.3 | A | A | A |
| example 4 | | | | |
| Experiment | −0.6 | B | A | B |
| example 5 | | | | |

### [Discussion]

A heating target was heated while applied with pressure by the heating device 200 provided with the separation plate 125 including the inclined part 125D. The separation plate 125 served as a heat diffusing plate. As the heating target, the print medium M on which the toner had been transferred was used. The print medium was printer paper of A4 size, “Excellent Gloss” having a size of 297 mm×210 mm, available from Oki Data Corporation, located in Tokyo, Japan. The toner was a yellow toner. As a result, the heating belt 122 slid smoothly against the separation plate 125, whereby the heating target was heated sufficiently. Therefore, the toner was fixed to the print medium M.

As described in Table 1, the moving characteristic of the heating belt 122, the durability of the heating belt 122, and the silent characteristic of the heating belt 122 were varied in accordance with the distance L1.

More specifically, the load torque increased in a case where the distance L1 was excessively great (Experiment example 1) or in a case where the distance L1 was excessively small (Experiment example 5). In contrast, the load torque hardly increased in a case where the distance L1 was 0 (zero) mm or around 0 (zero) mm (Experiment Examples 2 to 4).

In particular, in a case where the distance L1 was excessively great (Experiment example 1), the heating belt 122 was reversely curved by a great amount as a result of being in contact with the protrusion 127PA. This made it easier for the heating belt 122 to have fatigue. In a case where the distance L1 was excessively small (Experiment example 5), it was more difficult for the lubricant 126 to be fed to the gap between the heating belt 122 and the separation plate 125. This made it easier for an abnormal sound to occur as a result of friction between the heating belt 122 and the separation plate 125. The abnormal sound might have occurred for a reason that it was easier for the viscosity of the lubricant 126 to increase as a result of mixing of friction debris. The friction debris was generated upon friction between the heating belt 122 and the separation plate 125 as described above.

### [Conclusion]

As can be appreciated from the results described above, the heating target was heated stably by the heating device 200 when the separation plate 125 disposed between the heater 121 and the heating belt 122 included the inclined part 125D. In this case, each of the moving characteristic of the heating belt 122, the durability of the heating belt 122, and the silent characteristic of the heating belt 122 was improved in particular when the distance L1 was in a range from −0.3 mm to +0.3 mm, both inclusive. Hence, an improved heating characteristic was obtained in the heating device 200.

Some example embodiments and the modification examples thereof of the technology have been described above; however, embodiments of the technology are not limited to the example embodiments and the modification examples described above, and is modifiable in various ways.

For example, the heating device according to one embodiment of the technology is not limitedly applied to an image forming apparatus, and may be applied to any apparatus other than the image forming apparatus.

For example, the image forming apparatus according to one embodiment of the technology is not limited to a full-color printer, and may be a monochrome printer. For example, the image forming apparatus according to one embodiment of the technology is not limited to a printer, and may be any other apparatus such as a copying machine, a facsimile, or a multi-functional peripheral.

Furthermore, the technology encompasses any possible combination of some or all of the various embodiments and the modifications described herein and incorporated herein. It is possible to achieve at least the following configurations from the above-described example embodiments of the technology.

(1)

A heating device including:

a heating source;

a belt member that is heated by the heating source and moves in a predetermined moving direction;

a pressure-applying member that is brought into contact with the heating source with the belt member being disposed between the pressure-applying member and the heating source, and thereby provides a nip;

a plate member that is disposed between the heating source and the belt member, and includes an inclined part in an upstream region, a downstream region, or both, the upstream region being disposed upstream of the nip in the predetermined moving direction of the belt member, the downstream region being disposed downstream of the nip in the predetermined moving direction of the belt member, the inclined part being inclined to be away from the nip; and

a lubricant provided between the belt member and the plate member.

(2)

The heating device according to (1), in which the plate member includes the inclined part in the upstream region.

(3)

The heating device according to (1) or (2), in which

the belt member is heated with heat generated by the heating source, and

the plate member includes a heat diffusing member that diffuses the heat generated by the heating source.

(4)

The heating device according to any one of (1) to (3), further including:

a first protrusion member that is disposed in the upstream region and protrudes in a direction from the heating source toward the pressure-applying member; and

a second protrusion member that is disposed in the downstream region and protrudes in the direction from the heating source toward the pressure-applying member, in which

the heating source and the plate member are both disposed between the first protrusion member and the second protrusion member.

(5)

The heating device according to (4), in which

the heating source and the pressure-applying member are opposed to each other with the plate member being disposed between the heating source and the pressure-applying member, and

the first protrusion member has a tip that is positioned closer to the pressure-applying member than to the plate member in a direction in which the heating source and the pressure-applying member are opposed to each other.

(6)

The heating device according to (4) or (5), in which

the heating source and the pressure-applying member are opposed to each other with the plate member being disposed between the heating source and the pressure-applying member, and

the second protrusion member has a tip that is positioned closer to the plate member than to the pressure-applying member in a direction in which the heating source and the pressure-applying member are opposed to each other.

(7)

The heating device according to any one of (4) to (6), in which

the heating source is disposed between the first protrusion member and the second protrusion member,

a first storage space is provided between the first protrusion member and the heating source, the first storage space being a space in which the lubricant is stored,

a second storage space is provided between the second protrusion member and the heating source, the second storage space being a space in which the lubricant is stored, and

the first storage space has a volume that is greater than a volume of the second storage space.

(8)

An image forming apparatus including:

a developing section that attaches a toner to an electrostatic latent image;

a transfer section that transfers, onto a print medium, the toner attached to the electrostatic latent image; and

the heating device according to any one of (1) to (7) that fixes, to the print medium, the toner transferred onto the print medium.

According to the heating device or the image forming apparatus according to one embodiment of the technology, the plate member is disposed between the heat source and the belt member. Further, the plate member includes the inclined part in the upstream region, the downstream region, or both. The inclined part is inclined to be away from the nip. The upstream region is disposed upstream of the nip in the moving direction of the belt member. The downstream region is disposed downstream of the nip in the moving direction of the belt member. Hence, it is possible to obtain an improved heating characteristic.

Although the technology has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A heating device comprising:
a heating source;
a belt member that is heated by the heating source and moves in a predetermined moving direction;
a pressure-applying member that is brought into contact with the heating source with the belt member being disposed between the pressure-applying member and the heating source, and thereby provides a nip;
a plate member that is disposed between the heating source and the belt member, and includes an inclined part in an upstream region, a downstream region, or both, the upstream region being disposed upstream of the nip in the predetermined moving direction of the belt member, the downstream region being disposed downstream of the nip in the predetermined moving direction of the belt member, the inclined part being inclined to be away from the nip; and
a lubricant provided between the belt member and the plate member.

2. The heating device according to claim 1, wherein the plate member includes the inclined part in the upstream region.

3. The heating device according to claim 1, wherein
the belt member is heated with heat generated by the heating source, and
the plate member comprises a heat diffusing member that diffuses the heat generated by the heating source.

4. The heating device according to claim 1, further comprising:
a first protrusion member that is disposed in the upstream region and protrudes in a direction from the heating source toward the pressure-applying member; and
a second protrusion member that is disposed in the downstream region and protrudes in the direction from the heating source toward the pressure-applying member, wherein
the heating source and the plate member are both disposed between the first protrusion member and the second protrusion member.

5. The heating device according to claim 4, wherein
the heating source and the pressure-applying member are opposed to each other with the plate member being disposed between the heating source and the pressure-applying member, and
the first protrusion member has a tip that is positioned closer to the pressure-applying member than to the plate member in a direction in which the heating source and the pressure-applying member are opposed to each other.

6. The heating device according to claim 4, wherein
the heating source and the pressure-applying member are opposed to each other with the plate member being disposed between the heating source and the pressure-applying member, and
the second protrusion member has a tip that is positioned closer to the plate member than to the pressure-applying member in a direction in which the heating source and the pressure-applying member are opposed to each other.

7. The heating device according to claim 4, wherein
the heating source is disposed between the first protrusion member and the second protrusion member,
a first storage space is provided between the first protrusion member and the heating source, the first storage space being a space in which the lubricant is stored,
a second storage space is provided between the second protrusion member and the heating source, the second storage space being a space in which the lubricant is stored, and
the first storage space has a volume that is greater than a volume of the second storage space.

8. An image forming apparatus comprising:
a developing section that attaches a toner to an electrostatic latent image;
a transfer section that transfers, onto a print medium, the toner attached to the electrostatic latent image; and
a heating device including
a heating source,
a belt member that is heated by the heating source and moves in a predetermined moving direction,
a pressure-applying member that is brought into contact with the heating source with the belt member being disposed between the pressure-applying member and the heating source, and thereby provides a nip,
a plate member that is disposed between the heating source and the belt member, and includes an inclined part in an upstream region, a downstream region, or both, the upstream region being disposed upstream of the nip in the predetermined moving direction of the belt member, the downstream region being disposed downstream of the nip in the predetermined moving direction of the belt member, the inclined part being inclined to be away from the nip, and
a lubricant provided between the belt member and the plate member,
the heating device fixing, to the print medium, the toner transferred onto the print medium.
